(19) United States
(12) Patent Application Publication
(10) Pub. No.: US 2015/0220494 A1
(43) Pub. Date: Aug. 6, 2015

(54) Individualized Font Display Method And Device

(71) Applicant: ZTE CORPORATION, Shenzhen City (CN)

(72) Inventors: Lei Qin, Shenzhen City (CN); Chao Ma, Shenzhen City (CN)

(21) Appl. No.: 14/422,782

(22) PCT Filed: Jul. 15, 2013
(86) PCT No.: PCT/CN2013/079367

§ 371 Date: Mar. 25, 2015

(30) Foreign Application Priority Data
Aug. 24, 2012 (CN) 201210303234.4

(51) Int. Cl. G06F 17/21; H04L 29/08

(52) U.S. Cl. CPC G06F 17/214; H04L 67/02

(57) ABSTRACT

A method and apparatus for displaying an individualized font are disclosed. The method includes: according to character information input by a user, creating a font template consistent with writing habits of the user; according to the font template, creating a character library consistent with the writing habits of the user; and applying the character library to a terminal, and according to characters in the character library, displaying a character on the terminal. The embodiments of the present invention achieve the object of displaying an individualized font on a terminal by creating a character library consistent with the writing habits of a user, thereby increasing the display characteristics of the terminal and improving the user experience.

### CROSS-REFERENCE TO RELATED APPLICATION(S)

This application is the U.S. National Phase application of PCT application number PCT/CN2013/079367 having a PCT filing date of Jul. 15, 2013, which claims priority of Chinese patent application 201210303234.4 filed on Aug. 24, 2012, the disclosures of which are hereby incorporated by reference.

### TECHNICAL FIELD

The invention relates to the field of communication technology, and in particular, to a method and apparatus for displaying an individualized font.

### BACKGROUND OF THE RELATED ART

In information age, the function of the mobile phone is increasingly important, and has become an indispensable tool in people's life. After the basic function such as making telephone calls, transmitting messages and surfing on the internet meet the people's needs, the personalization becomes users' new demands for the mobile phone.

One of important functions of the mobile phone is displaying information, which is inseparable from the font. At present, a user of the mobile phone no longer satisfies with a single built-in font of the mobile phone, and there are also a large number of individualized fonts in the APP Store on the internet, such as star font, YouYuan, crazy cursive script etc., but there is currently no mobile phone which can display according to a user's own font. In the other terminals, there is also no function of displaying a character according to a user's own font.

### SUMMARY OF THE INVENTION

The technical problem to be solved by the embodiments of the present invention is to provide a method and apparatus for displaying an individualized font, to solve the problem in the related technology that the terminal cannot display the individualized font.

In order to solve the above technical problem, in an aspect, the embodiments of the present invention provide a method for displaying an individualized font, comprising:

according to character information input by a user, creating a font template consistent with writing habits of the user;

according to the font template, creating a character library consistent with the writing habits of the user; and

applying the character library to a terminal, and according to characters in the character library, displaying a character on the terminal.

Alternatively, the character information input by the user is characters and/or basic units which constitute a character.

Alternatively, after creating the font template, the terminal transmitting the font template to a cloud server;

the cloud server creating the character library according to the font template; and

the terminal downloading the character library from the cloud server, applying the character library to the terminal, and displaying a character on the terminal according to the characters in the character library.

Alternatively, after creation of the character library is completed, notifying a second user of a message that the character library of the user has been created.

Alternatively, after the user acquires a permission of the second user, downloading a character library of the second user from the cloud server, and binding the character library of the second user with identity information of the second user; and when the second user transmits character information to the user, displaying the character information on the terminal according to characters in the character library of the second user.

In another aspect, the embodiments of the present invention further provide an apparatus for displaying an individualized font, comprising:

a font template creation unit, configured to create a font template consistent with writing habits of a user according to character information input by the user;

a character library creation unit, configured to create a character library consistent with the writing habits of the user according to the font template; and

a character display unit, configured to apply the character library to a terminal, and display a character on the terminal according to characters in the character library.

Alternatively, the character information input by the user is characters and/or basic units which constitute a character.

Alternatively, the font template creation unit is configured on the terminal, and after creating the font template, transmits the font template to a cloud server;

the character library creation unit is configured on the cloud server, and creates the character library according to the font template; and

the character display unit is configured on the terminal, and downloads the character library from the cloud server, applies the character library to the terminal, and displays a character on the terminal according to the characters in the character library.

Alternatively, the apparatus further comprises:

a notification unit, configured to notify a second user of a message that the character library of the user has been created after creation of the character library is completed.

Alternatively, the apparatus further comprises:

a download unit, configured to download a character library of the second user from the cloud server after the user acquires a permission of the second user, and bind the character library of the second user with identity information of the second user; and when the second user transmits the character information to the user, display the character information on the terminal of the user according to characters in the character library of the second user.

The embodiments of the present invention have the following beneficial effects:

The embodiments of the present invention achieve the purpose of displaying an individualized font on a terminal by creating a character library consistent with writing habits of a user, which increases the display characteristics of the terminal and improves user experience.

### BRIEF DESCRIPTION OF THE DRAWINGS

FIG. 1 is a flowchart of a method for displaying an individualized font according an embodiment of the present invention; and

FIG. 2 is a structural diagram of an apparatus for displaying an individualized font according an embodiment of the present invention.

### PREFERRED EMBODIMENTS OF THE PRESENT INVENTION

The present invention will be described in detail below in conjunction with accompanying drawings and embodiments. It should be understood that the specific embodiments described here are only used to explain the present invention instead of limiting the present invention.

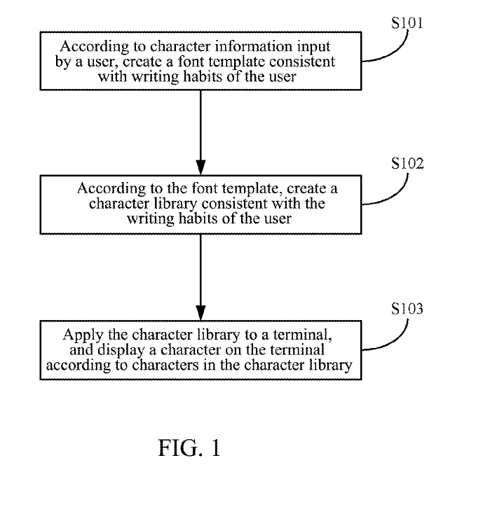

As shown in FIG. 1, the embodiments of the present invention relate to a method for displaying an individualized font, which comprises the following steps.

In step S101, according to character information input by a user, a font display apparatus creates a font template consistent with writing habits of the user;

There are many types of languages in the world. Although each character in each language is different, it is comprised of some basic units. By taking a Chinese character as an example, every character is comprised of a horizontal stroke, a vertical stroke, a left-falling stroke, a right-falling stroke, a raising stroke etc., i.e.: each stroke is a basic unit of the Chinese characters. The English character is more simple. Each word is comprised of a combination of some of 26 letters. Therefore, each letter is a basic unit of the English characters. Other languages are similar. When people write, the same basic unit which is written should have similarities. Consequently, by making use of this, if a user writes a few words or basic units of a character, writing habits of the user are acquired therefrom. The writing habits are used as a rule, to extract basic units belonging to the user. In this way, a set of font templates belonging to user can be created. Of course, for the sake of accuracy, the character information written by the user should include all the basic units which constitute a character as much as possible.

By taking a mobile phone as an example, an application or a function similar to “my font” is implemented on the mobile phone and the font of the user may be acquired through such application or function. For example, if the handwriting is available on the user's mobile phone, the user may write through a writing pad, and when the user run the “my font” application, a corresponding interface is invoked to enable the user to write, and then the character is used as a template to be firstly stored in the mobile phone. If the handwriting function is not available on the terminal, the user may manually write through a tool such as painting etc.

In step S102, according to the font template, the font display apparatus creates a character library consistent with the writing habits of the user;

In this step, after the font template is acquired, i.e., all the basic units which are consistent with writing habits of the user and constitute a character are acquired, a character library belonging to the user can be created by utilizing these basic units.

By taking a mobile phone as an example, after acquiring the font template, the mobile phone transmits the font template to the cloud server by transmitting a multimedia message to a cloud server or using various communication methods such as TCP/IP protocols etc. The cloud server will create a character library which belongs to the user according to the font template. The cloud server will create a database which will record terminal information (such as a mobile phone number) and the font template and the character library of the terminal. The terminal and the database form a binding relationship.

In step 103, the font display apparatus applies the character library to a terminal, and displays a character on the terminal according to characters in the character library.

In this step, if the font display apparatus applies the created character library to the terminal, the terminal will use characters in the newly created character library for display when displaying characters, i.e., displaying characters consistent with the writing habits of the user.

Still by taking a mobile phone being the terminal as an example, after creating and storing the character library, the cloud server notifies the terminal that the character library has been created and whether the character library is to be downloaded by using a short message or various communication methods such as TCP/IP protocols etc. As for how to prompt a user by the terminal, there are various implementation methods, such as using a prompt dialog box, or adopting a notification method similar to that of the existing android system. If the user chooses to download, the mobile phone can download the font onto the mobile phone. Thus, all of fonts displayed on the terminal are handwriting fonts of the user himself/herself, and the user will have a lot of additional kindness and fun.

In addition, after creation of the character library is completed, the font display apparatus may also notify a second user of a message that the character library of the user has been created. By taking a mobile phone as an example, the notification manner can adopt the following two ways: 1. after the a message that the character library has been created prompted by the cloud server is received by the mobile phone, a notification message is transmitted to contacts (a part of the contacts or all the contracts) on the address book; and 2. if the mobile phone transmits a message to a contract using the characters in the created character library of the user, when the message arrives at the mobile phone of the contract, if it is found that the mobile phone does not install the created character library of the user, prompt information similar to “the handwriting character library has been created by the user on the cloud server, whether to download” is transmitted to the counterpart, so as to notify the counterpart.

The font display apparatus can also be used by downloading the created character library of the second user, and a specific method comprises the following content.

The second user may store a set of handwriting font character libraries of his/her own on the cloud server. Another advantage of storage on the cloud server is that once a first user acquires a permission of the second user, the font display apparatus can download the handwriting font character library of the second user from the cloud server. Thus, the font display apparatus can bind the character library of the second user with identity information of the second user (such as mobile phone number) on the mobile phone, and once the second user transmits character information such as a short message or a letter to the first user, the font display apparatus can display the font of the second user on the mobile phone. It can be imagined that during a chat using short messages, QQ or other chat tools on the mobile phone, your handwriting font and your friends' (colleagues, classmates etc.) handwriting font are displayed, which will be an interesting thing.

As to how to acquire the permission of others, the font display apparatus may transmit an application message, and after receiving an agreement from the counterpart, the font display apparatus may acquire the character library of the counterpart from the cloud server and store it on the terminal.

In the above embodiment, creation and storage of a character library by the cloud server is taken as an example. Of course, creation and storage of a character library can be implemented without the cloud server, for example, creation and storage of a character library can be implemented by a mobile phone or a base station. Nevertheless, creation and storage of a character library by the cloud server can reduce the internal consumption of the mobile phone and increase the speed for creating the character library.

In the following, the whole flow of a user acquiring the handwriting character library will be described by means of a specific instance, which specifically comprises the following steps.

In step 201, a terminal (mobile phone) uses a function or application similar to “my font” to create a font template.

In step 202, the terminal may transmit the font template to a cloud server by transmitting a multimedia message or using various manners such as TCP/IP protocols etc.

In step 203, the cloud server receives the font template of the terminal.

In step 204, the cloud server checks whether the font template is received first time, if so, proceed to step 205, if not, turn to step 206.

In step 205, the cloud server builds a database bound with the terminal, i.e., this database is used to store the font template of the terminal and the created character library. If the database is created successfully, proceed to step 208, and if the database fails to be created for some reasons, such as problems of the space of the server, proceed to step 209.

In step 206, as the database has previously been created, there is no need to create the database, and an old character library template is substituted with a new character library template directly.

In step 207, the cloud server creates a character library using the new library template, and substitutes the old character library originally stored in the database, and if successful, turn to step 208; otherwise proceed to step 209.

In step 208, the cloud server notifies the terminal that the character library is created successfully.

In step 207: the terminal prompts the user that the character library is created successfully, and the terminal downloads and uses the character library according to an instruction of the user.

In step 209, the cloud server notifies the terminal that the character library fails to be created.

In step 210, the flow ends.

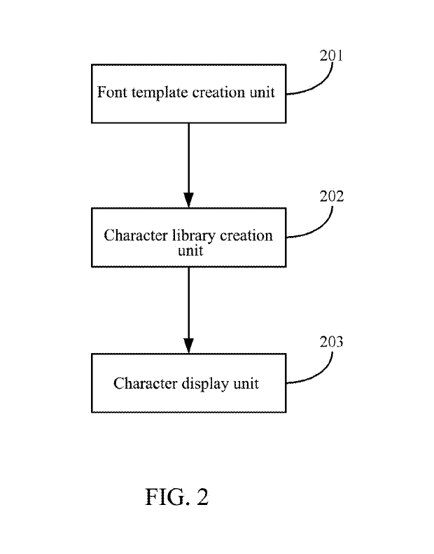

As shown in FIG. 2, the embodiments of the present invention further relate to an apparatus for implementing the above method for displaying an individualized font, which comprises:

a font template creation unit 201, configured to create a font template consistent with writing habits of a user according to character information input by the user;

a character library creation unit 202, configured to create a character library consistent with the writing habits of the user according to the font template; and

a character display unit 203, configured to apply the character library to a terminal, and display a character on the terminal according to characters in the character library.

Wherein, the character information input by the user is characters and/or basic units which constitute a character.

the font template creation unit 201 is arranged on the terminal, and is configured to transmit the font template to a cloud server after creating the font template;

the character library creation unit 202 is arranged on the cloud server, and is configured to create the character library according to the font template; and

the character display unit 203 is arranged on the terminal, and is configured to download the character library from the cloud server, apply the character library to the terminal, and display a character on the terminal according to the characters in the character library.

In addition, the above apparatus further comprises a notification unit, configured to notify a second user of a message that the character library of the user has been created after creation of the character library is completed; and

a download unit, configured to download a character library of the second user from the cloud server after the user acquires a permission of the second user, and bind the character library of the second user with identity information of the second user; and when the second user transmits the character information to the user, display the character information on the terminal of the user according to characters in the character library of the second user.

It can be seen from the above embodiments that the embodiments of the present invention achieve the purpose of displaying an individualized font on a terminal by creating a character library consistent with writing habits of a user, which increases the display characteristics of the terminal and improves user experience.

Although preferable embodiments of the present invention have been disclosed for purpose of illustration, those skilled in the art should understand that various improvements, additions, and substitutions are possible, and therefore, the scope of the present invention should not be limited to the above embodiments.

### INDUSTRIAL APPLICABILITY

The embodiments of the present invention achieve the purpose of displaying an individualized font on a terminal by creating a character library consistent with writing habits of a user, which increases the display characteristics of the terminal and improves user experience.

1. A method for displaying an individualized font, comprising:
according to character information input by a user, creating a font template consistent with writing habits of the user;
according to the font template, creating a character library consistent with the writing habits of the user; and
applying the character library to a terminal, and according to characters in the character library, displaying a character on the terminal.

2. The method according to claim 1, wherein, the character information input by the user is characters and/or basic units which constitute a character.

3. The method according to claim 1, wherein, after creating the font template, the terminal transmitting the font template to a cloud server;
the cloud server creating the character library according to the font template; and
the terminal downloading the character library from the cloud server, applying the character library to the terminal, and displaying a character on the terminal according to the characters in the character library.

4. The method according to claim 3, further comprising: after creation of the character library is completed, notifying a second user of a message that the character library of the user has been created.

5. The method according to claim 4, further comprising: after the user acquires a permission of the second user, downloading a character library of the second user from the cloud server, and binding the character library of the second user with identity information of the second user; and when the second user transmits character information to the user, displaying the character information on the terminal according to characters in the character library of the second user.

6. An apparatus for displaying an individualized font, characterized by comprising:
a font template creation unit, configured to create a font template consistent with writing habits of a user according to character information input by the user;
a character library creation unit, configured to create a character library consistent with the writing habits of the user according to the font template; and
a character display unit, configured to apply the character library to a terminal, and display a character on the terminal according to characters in the character library.

7. The apparatus according to claim 6, wherein, the character information input by the user is characters and/or basic units which constitute a character.

8. The apparatus according to claim 6, wherein,
the font template creation unit is configured on the terminal, and after creating the font template, transmits the font template to a cloud server;
the character library creation unit is configured on the cloud server, and creates the character library according to the font template; and
the character display unit is configured on the terminal, and downloads the character library from the cloud server, applies the character library to the terminal, and displays a character on the terminal according to the characters in the character library.

9. The apparatus according to claim 8, further comprising:
a notification unit, configured to notify a second user of a message that the character library of the user has been created after creation of the character library is completed.

10. The apparatus according to claim 9, further comprising:
a download unit, configured to download a character library of the second user from the cloud server after the user acquires a permission of the second user, and bind the character library of the second user with identity information of the second user; and when the second user transmits the character information to the user, display the character information on the terminal according to characters in the character library of the second user.

11. The method according to claim 2, wherein,
after creating the font template, the terminal transmitting the font template to a cloud server;
the cloud server creating the character library according to the font template; and
the terminal downloading the character library from the cloud server, applying the character library to the terminal, and displaying a character on the terminal according to the characters in the character library.

12. The method according to claim 11, further comprising: after creation of the character library is completed, notifying a second user of a message that the character library of the user has been created.

13. The method according to claim 12, further comprising: after the user acquires a permission of the second user, downloading a character library of the second user from the cloud server, and binding the character library of the second user with identity information of the second user; and when the second user transmits character information to the user, displaying the character information on the terminal according to characters in the character library of the second user.

14. The apparatus according to claim 7, wherein,
the font template creation unit is configured on the terminal, and after creating the font template, transmits the font template to a cloud server;
the character library creation unit is configured on the cloud server, and creates the character library according to the font template; and
the character display unit is configured on the terminal, and downloads the character library from the cloud server, applies the character library to the terminal, and displays a character on the terminal according to the characters in the character library.

15. The apparatus according to claim 14, further comprising:
a notification unit, configured to notify a second user of a message that the character library of the user has been created after creation of the character library is completed.

16. The apparatus according to claim 15, further comprising:
a download unit, configured to download a character library of the second user from the cloud server after the user acquires a permission of the second user, and bind the character library of the second user with identity information of the second user; and when the second user transmits the character information to the user, display the character information on the terminal according to characters in the character library of the second.
